(19) United States
(12) Patent Application Publication
(10) Pub. No.: US 2025/0282560 A1
(43) Pub. Date: Sep. 11, 2025

(54) DEVICE AND METHOD FOR LOADING AND UNLOADING TRANSPORT UNITS OF AN OVERHEAD CONVEYOR SYSTEM

(71) Applicant: FERAG AG, CH-8340 HINWIL (CH)

(72) Inventor: Roberto FENILE, Wetzikon (CH)

(73) Assignee: FERAG AG, CH-8340 HINWIL (CH)

(21) Appl. No.: 19/073,965

(22) Filed: Mar. 7, 2025

(30) Foreign Application Priority Data
Mar. 8, 2024 (CH) 000283/2024
Mar. 5, 2025 (EP) 25161425.1

(51) Int. Cl. B65G 47/61; B65G 17/18; B65G 17/20

(52) U.S. Cl. CPC B65G 47/61; B65G 17/18; B65G 17/20

(57) ABSTRACT

A loading device for loading transport units in an overhead conveyor device includes an overhead conveyor device having at least one transport unit with a transport pouch mounted on a carrier element in a pivotably suspended manner. The transport unit is conveyed along a conveying path and the transport pouch includes a rear wall that is mounted on the carrier element of the transport unit in a pivotably suspended manner and the rear wall has two bearing points arranged laterally on one side of the rear wall. A front wall is movably connected to the rear wall. A pivoting device interacts with the front wall to pivot the transport pouch during conveying along a first section of the conveying path from a vertical first orientation to a pivoted second orientation. A first supporting device supports a transport pouch pivoted into the second orientation during conveying along a second section by the two bearing points of the rear wall of the transport pouch. A second supporting device supports the front wall during conveying along a third section of the conveying path. The first supporting device and the second supporting device are configured so that in a region in which the second section and the third section of the conveying path overlap, the transport pouch has a determined, geometrically defined opening.

### CROSS REFERENCE TO RELATED APPLICATIONS

This patent application claims priority to Swiss Patent Application No. CH000283/2024, filed 8 Mar. 2024 and European Patent Application No. EP 25161425.1, filed 3 Mar. 2025. The aforementioned priority documents, corresponding to this invention, to which a foreign priority benefit is claimed under Title 35, United States Code, Section 119, and Title 37, United States Code, Section 1.55, and their entire teachings are incorporated, by reference, into this specification.

The above-referenced applications are hereby incorporated by reference herein in its entirety and are made a part hereof, including but not limited to those portions which specifically appear hereinafter.

### BACKGROUND OF THE INVENTION

### Field of the Invention

The present invention relates to the field of transport and conveying technology. It relates to devices for loading and unloading transport pouches conveyed in a suspended manner and to an overhead conveyor installation comprising such devices.

### Discussion of Related Art

Overhead conveyor systems are playing an increasingly important role in modern logistics, in particular in intralogistics, in order to meet the requirements of the constantly growing online trade. These systems, which are used for storing, order picking and transporting units of goods in automated warehouses and production facilities, have proven to be particularly efficient. Because units of goods can be suspended directly from conveying elements or placed in transport units such as transport pouches, overhead conveyor systems offer a versatile solution to logistical challenges.

Particularly relevant for modern intralogistics applications are gravity-fed, rail-guided overhead conveyor systems, such as those described, for example, in US 2017/275826 A1, US 2018/215547 A1 and US 2017/282317 A1. These documents underline the technical development and the variety of possible applications of overhead conveyor systems.

In order to meet the increasing requirements, in particular with regard to fast and efficient processing of units of goods, automation within intralogistics is becoming increasingly important. Semi-automated and fully automated systems for introducing units of goods into transport units or removing units of goods from transport units are important for increasing process efficiency. Modern approaches for automating and optimizing this process are described in detail in various patent documents.

With regard to loading, CH 719181 A1 discloses a loading management system for conveyor systems with multiple conveyors and transfer stations for efficient handling and sorting of units of goods. Furthermore, CH 716519 A1 describes a transfer device for units of goods in overhead conveyor systems, which allows loading and unloading by means of directionally adapted conveyor units. Finally, WO 2020/232496 A1 describes an overhead conveyor system designed for transporting units of goods by means of flexible transport pouches made of flexible material and a specific loading station. It is characterized by a measuring device that determines the expansion of the pouch bodies in the transport position.

CH 713089 A1 also presents a method and a device for opening a transport pouch of an overhead conveyor system by applying a pushing force to a pushing element, whereby the front wall and rear wall of the pouch are moved for loading or unloading. A loading station comprises an overhead conveyor system with at least one transport pouch with a suspension eye and a transport pouch pivotably suspended from the suspension eye. The overhead conveyor system is designed to convey the at least one transport pouch along a conveying path in a conveying direction. The transport pouch has a rear wall which is pivotably suspended from the suspension eye of the transport pouch. A front wall is pivotably connected to the rear wall and runs ahead of the rear wall in the conveying direction. A pushing element of the transport pouch is designed to move the front wall away from the rear wall when force is applied by a pushing device of the stationary loading station, thus opening the transport pouch. At the same time, the transport pouch is tilted into an inclined position. When the transport pouch is open, the front wall rests against a roller carpet on the loading station so that goods and unit loads can be loaded into the open pouch.

Unloading piece goods from overhead conveyor systems is a critical step in the logistics chain that has a significant impact on the efficiency, speed and safety of further goods processing and distribution. Optimized unloading not only ensures the smooth transfer of units of goods to the next processing areas or storage areas but also minimizes the risk of damage and improves working conditions for staff. In a fast-moving market environment, in which time savings and cost reduction are important competitive advantages, innovations in unloading technology are of central importance.

EP 3712091 A1, for example, shows a method and a device for unloading transported goods from a laterally open transport pouch by raising a part of the support surface, causing the goods to slide off sideways.

WO 2018/142243 A1 discloses an unloading station for an overhead conveyor system with a conveyor rail, a conveyor drive, and a plurality of overhead adapters conveyed along the conveyor rails by means of the conveyor drive, on which conveyor containers in the form of transport pouches can be conveyed. The conveyor rail has an inclined section that deviates from the horizontal and is inclined downwards in the conveying direction. The unloading station has a device for emptying these suspended transport pouches, with an opening unit for opening these conveyor units at an opening position, which is arranged along said inclined section of the conveyor rail. The opening unit includes a goods discharge area arranged below the conveyor rail for discharging goods discharged from the conveyor containers, in the form of a circulating conveyor belt for taking unit loads from the transport pouches and a curved chute adjoining the conveyor belt. At the opening position, the goods discharge surface slopes downwards from the horizontal in the conveying direction, thus forming a sliding surface on which the discharged goods can slide downwards. A suitable arrangement of the conveyor belt and the conveyor rail continuously reduces the distance between the two in the conveying direction, so that the transport pouches are tilted backwards in the conveying direction at the opening position to such an extent that the opening of the pouch now points downwards. The transport pouch is therefore open on one underside and the goods contained in the conveyor container fall or slide onto the goods discharge surface driven by gravity.

Finally, DE 102022002687 A1 is aimed at the efficient retrieval of piece goods from a transport pouch storage system. This comprises various buffer stages in order to provide the piece goods in a predetermined sequence.

The following sections discuss the documents that reflect the relevant prior art.

DE 102012018925 A1 relates to a suspended pouch conveyor installation with a loading station and specially designed pouches that are optimized for the transport as well as the loading and unloading of piece goods and can be loaded and unloaded from the side. The system comprises a suspended conveyor for transporting pouches along a guide rail, wherein the pouches are suspended vertically in the transport position and can be aligned horizontally for loading. Each transport pouch is equipped with a suspension device for pivotable connection to the guide rail and has a substantially closed rear wall, a lid, a front wall and a base, which are permanently pivotably connected to each other and define two lateral pouch openings. The rear wall of the transport pouch is wider than its front wall, resulting in laterally protruding wing areas over the entire length of the rear wall. The loading station includes a deflection device that rotates a transport pouch from a vertical transport position to a horizontal loading position during transportation. Pivoting is achieved by the wing areas of the rear wall abutting against the upstream edge of the deflection device. The transport pouch is stopped at a loading position. At the loading position, the rear wall of the transport pouch is in a horizontal loading position and the wing sections are supported over their entire length, while the front wall, which is suspended from the rear wall via the lid and the base, hangs freely downwards unsupported. A goods item is pushed into the transport pouch through the side opening of the pouch and then rests on the front wall. This system has several disadvantages, particularly with regard to the loading station. The transport pouch is supported exclusively by the interaction of its wing areas with the deflection device. There is no external support for the front wall during the loading process. The resulting mechanical load reduces the service life of a transport pouch, requires additional reinforcing elements for the transport pouch and limits the maximum possible weight of a transportable item. The exclusive reliance on the wing areas to stabilize and align the pouches also limits the flexibility of the system and increases the risk of pouches tipping, buckling or moving undesirably under the load. Furthermore, it is not optimal for the pouch to be both aligned and supported by means of one device, namely the deflection device. This focus on a single component for two essential functions of the loading process carries inherent risks. The precise alignment and simultaneous support by the deflection device require a high degree of accuracy and reliability of the system. Any deviation or malfunction of the deflection device can lead to inaccurate positioning of the pouch, which in turn affects the loading efficiency. Finally, another significant drawback is the need for a specific shape of the rear wall of the pouch, which must be wider than the front wall and the lid to allow space for the wing areas. This design requirement does not allow for a simple retrofit of existing pouches, but rather requires a complete rebuild or redesign of the pouches to support them during the loading process by the wing areas. This necessity significantly undermines the flexibility and application possibilities of the overhead conveyor installation, in particular when it comes to integrating it into conveyor installations with existing pouches of different designs.

WO 2017/088078 A1 describes a transport pouch and associated devices for transporting and handling piece goods, in particular in automated storage and conveying systems. The transport pouch, designed for suspended transportation by means of an overhead conveyor system, includes a receiving compartment with a pouch rear wall and a pouch wall, which together form an opening for the transported goods. An essential feature is the at least one control element on the pouch wall, which interacts with a slotted guide of the conveyor to move the receiving compartment between an open and a compact position. The document also comprises a device for feeding the transport pouches by means of a feed conveyor, which brings the transported goods to a transfer zone where they are transferred into the pouches. The pouches are configured to be moved through the transfer zone in a horizontal formation, with gravity guiding the transported goods into the pouches.

US 2020/0189846 A1 discloses an order-picking system and a method for order-picking articles, wherein articles are removed from a collection of articles, combined into article groups and output in the form of these groups for further processing. Combining the articles into article groups takes place in pouches or baskets suspended on a suspension conveyor. On the input side, the system comprises an article collection with articles intended for order-picking and at least one filling device connected to it for the pouches or baskets. On the output side, there is an emptying device for pouches or baskets filled with the article groups. Arranged between the filling device and the emptying device is a suspension conveyor which connects the filling device to the emptying device.

DE 102016208866 A1 describes a conveyed goods transfer station for overhead conveyor systems which makes it possible to open and close conveyed goods transporting receptacles on guide rails in order to receive or discharge conveyed goods. The station provides a high-speed operating mode, supported by a lift/tilt device that moves the receptacles to a transfer position. In addition, the conveyor transfer station includes a drive means for the receptacle movement, a safety mechanism and a bucket wheel with lifting buckets.

JP H07/304514 A describes an overhead conveyor system with transport pouches for folded textile products. The transport pouches consist of opposing side walls which are pivotally connected to each other at their lower ends in order to hold a folded textile product clamped therebetween. A connecting link is pivotably attached to each side wall, whereby the two connecting links are in turn pivotably connected to each other on a horizontal axis of rotation. A suspension of the trolley is attached to the same axis of rotation. To empty the transport pouches, they are pivoted from a vertical transport position by more than 90° around the axis of rotation, so that the weight of the transport pouch pushes the two side walls apart and releases the clamped transported goods. The transported goods then slide out of the transport pouch via a chute onto a belt conveyor.

The dependency on a mechanical pin to activate the release mechanism of the holder introduces potential weaknesses into the system. First of all, this construction design of the holder with the pin makes the overall construction design more complicated and therefore more expensive. In addition, the installation of such a mechanism requires precise manufacturing and assembly, which increases production costs. Finally, this component is subject to increased wear, which can affect the reliability of the device over time.

The focus of JP H07/304514 A on conveying textile products and the specific design of the pin mechanism as well as the entire holder system brings an inherent limitation in terms of the weight and type of piece goods that can be effectively transported and stored. While textile products are typically relatively light in weight, heavier piece goods would exert additional mechanical stress on the pin, the holder and the pivoting connecting elements. This overload could lead to accelerated wear of the components, increase the risk of malfunction and ultimately shorten the life of the conveyor system.

The construction design is therefore not readily transferable to applications that require the transport and storage of heavier piece goods. Such a transfer would require a new concept or considerable adjustments to the holder system in order to cope with the higher load. In particular, the pin and the associated mechanical connecting elements would have to be reinforced in order to absorb the additional forces without deformation or failure.

DE 102004018569 A1 describes a collecting and conveying device for collecting and transporting objects, especially items of clothing, in a sorted manner. The collecting device consists of a collecting pouch with a frame and a pouch pocket suspended therefrom. The frame integrates a driver element which enables a pivoting connection transverse to the conveying direction so that the pouch pocket is open in the horizontal position and closed in the vertical position. The conveying device transports the collecting pouch and is combined with an opening device that transfers the collecting pouch to an open state during transport.

DE 102008026720 A1 discloses a transport pouch and a conveyor installation for automating the transport and unloading process of piece goods. The transport pouch consists of a dimensionally stable carrying wall with an upper pivotable clamp and a flexible base side wall. The carrying wall is equipped with couplings which are used in the lower region to receive counter-coupling means of the base side wall, allowing the pouch to be closed at the base. A mechanism for opening the couplings enables the goods to be unloaded automatically by opening downwards. The associated conveyor installation has conveyor rails with drivers, closing stations for closing the pouch, loading stations for spacing the bottom side wall from the carrying wall for loading, and unloading stations for automatically opening the couplings and unloading the goods.

DE 102014203298 A1 relates to a hanging conveyor device for transporting goods in transport bins. This device includes transport bins with two bin side walls that are connected via a pivot axis to open or close a material receiving area. A loading station with a vertically adjustable loading platform makes it easy to load and unload the bins. The arrangement offers flexibility for different transport bin sizes and improves handling through automatic or manual control. In addition, transport bins can be optimally positioned by adjusting the loading platform vertically and horizontally.

DE 202017105508 U1 discloses a transport pouch for automatic conveyor installations comprising a front wall, a rear wall and a pivotable retaining bracket. The walls are secured in an articulated manner at the top of the retaining bracket. At least one coupling element is located at the bottom of the front wall. A channel-like or trough-like base element with two side walls is integrated, one side being secured in an articulated manner to the rear wall and the other side having at least one counter-coupling element for the coupling element.

EP 2130968 A1 comprises a transport pouch and a conveyor system with devices for loading and unloading the transport pouch. The transport pouch has a dimensionally stable carrying wall and a second, flexible wall, which also forms the bottom of the pouch. A pivotable bracket is attached to the upper end of the carrying wall, to which the flexible second wall is pivotably attached. The carrying wall and second wall are connected at their lower end via a reversibly detachable coupling. The carrying wall runs ahead of the second wall in the conveying direction. The transport pouch can be unloaded automatically by opening the coupling at an unloading station via actuating means attached to the upper area of the carrying wall. The goods transported in the transport pouch then fall downwards out of the transport pouch through the resulting lower opening. The open coupling of the transport pouch must then be closed again at a complex closing station. To fill the transport pouch, a baffle guide is provided at a loading station that, when the transport pouch is conveyed, swivels the bracket upwards via lateral protrusions so that the distance between the carrying wall and the second wall increases, and a lateral pouch opening is created through which the transport pouch can be filled manually from the side

An alternative loading station for said transport pouch is known from DE 102008061685 A1.

US 2024/0417194 A1 describes an unloading device for similar transport pouches of an overhead conveyor system that can be reversibly closed at a lower end with a coupling. An obliquely sloping chute runs parallel to a section of the overhead conveyor arranged above it, which slopes downwards in the conveying direction. The filled transport pouches are conveyed on the overhead conveyor in the conveying direction, with the transport pouches on the sloping section of the overhead conveyor resting on the chute with the coupling at the bottom. At a lower end of the sloping section of the overhead conveyor, an opening unit opens the coupling of the transport pouch so that the goods unit slides out of the open transport pouch onto the chute and from there onto a horizontal belt conveyor.

EP 3301043 A1 relates to a transport pouch for overhead conveyor installations that prevents lateral displacement and entanglement with neighboring pouches. The transport pouch has adherent contact surfaces on the outer sides of the front and/or rear side walls, equipped with a friction layer made of a friction material to prevent lateral displacement of two adjacent pouches. The adherent contact surfaces can contain surface structures with elevations and recesses that enable a mechanical connection by positive locking.

WO 2017/088076 A1 relates to a transport pouch for suspended transport by means of overhead conveyors, characterized by a rear wall and front wall aligned transverse to the transport direction, which are movably connected at the upper and lower ends of the pouch. The pouch changes between a filling position and an empty position, with the front wall changing its position relative to the rear wall, and can be secured to the transport device by means of connecting means. Finally, first guide elements on the rear wall and optional second guide elements on the front wall allow for precise guidance.

CH 713082 A1 shows devices for loading and unloading transport pouches of an overhead conveyor. The transport pouches have a front wall and a rear wall, which are pivotably connected to one another. Roller elements are arranged at a lower end of the rear wall and at an upper end of the front wall. To load an empty transport pouch, it is tilted from a hanging transport position into a loading position. To do this, a baffle guide is moved upwards, which interacts with the roller elements at the lower end of the rear wall of the transport pouch. The overhead conveyor is stopped when the rear wall is oriented horizontally, and said roller elements engage in a detent recess on the baffle guide. A roller conveyor is raised, which finally protrudes through openings in the front wall of the transport pouch in the loading position. A goods item is now fed horizontally and pushed into the open transport pouch, where it rolls on the roller conveyor inside the transport pouch. The roller conveyor and the baffle guide are then lowered again until the roller elements at the lower end of the rear wall of the transport pouch are free again and the now filled transport pouch swivels back into the transport position. The transport pouch is now conveyed further on the overhead conveyor. To unload a filled transport pouch, it is tilted from a suspended transport position into an unloading position. To do this, a baffle guide is moved upwards, which interacts with the roller elements at the lower end of the rear wall of the transport pouch. The overhead conveyor is stopped when the said roller elements engage in a detent recess on the baffle guide and the rear wall is oriented horizontally. A segment of the overhead conveyor is then lowered together with the carriage of the transport pouch so that the front wall and rear wall are now inclined downwards in the conveying direction and a roller track protrudes through the openings in the front wall. The goods item now rolls out of the transport pouch on the roller conveyor, driven by gravity. Such devices have several moving elements, which increases the complexity of the device. In addition, the turnover speed is limited by the time required for the vertical movement of the baffle guide and other elements.

The prior art has a number of disadvantages. Firstly, today's technical solutions are often characterized by a high degree of complexity in their construction designs, which leads to higher acquisition and maintenance costs. Secondly, there is a challenge in the alignment and stabilization of suspended transport units, e.g., transport pouches, during the loading and unloading operation. Many systems do not provide specific mechanisms to support alignment, which affects the precision and efficiency of the loading and unloading process. Thirdly, the prior art does not sufficiently discuss and address the issue of forces acting on suspended conveyor units during the loading and unloading operation, wherein higher forces can lead to an increased risk of rapid wear of the overhead conveyor elements. Finally, conveyor systems often require a custom-made transport pouch that is precisely tailored to the technical solution, wherein a simple retrofit of existing pouches is not possible. Rather, a complete redesign is required, which incurs additional costs.

There is a general need for improvement in this field of technology.

### SUMMARY OF THE INVENTION

In this description, the terms goods, unit of goods, merchandise, article, piece goods, goods items, and piece good items are used synonymously, and may include in particular individual objects of goods, but also packaged goods such as packages, and in general objects which can be handled individually, in particular also semi-finished products, spare parts, etc.

It is an object of the invention to counteract at least some of the disadvantages of the prior art. In particular, the invention is intended to provide a simpler mechanical solution as well as more precise alignment and good stabilization of the overhead conveyor elements during the loading and unloading operation, while at the same time reducing the forces acting on the overhead conveyor elements.

These and other objects are substantially achieved by a device according to the independent claim. Further advantageous embodiments follow from the dependent claims and the description.

The solution according to the invention can be further improved by various embodiments, each of which is advantageous in itself, and, unless otherwise specified, can be combined with one another as desired. These embodiments and the advantages associated therewith are discussed below.

A first aspect of the invention relates to a loading device for loading transport units in an overhead conveyor device.

Such a loading device according to the invention comprises an overhead conveyor device having at least one transport unit with a carrier element and a transport pouch mounted on the carrier element in a pivotably suspended manner, wherein the overhead conveyor device is designed to convey the at least one transport unit along a conveying path in a conveying direction, wherein the transport pouch of the at least one transport unit comprises a rear wall that is mounted on the carrier element of the transport unit in a pivotably suspended manner, and wherein the said rear wall has two bearing points that are each arranged projecting laterally on one side of the rear wall, and a front wall that is movably connected to the rear wall and runs ahead of the rear wall in the conveying direction; a pivoting device that is configured to interact with the front wall of a transport pouch of a transport unit conveyed along the conveying path of the overhead conveyor device, in order to pivot the transport pouch during conveying along a first section of the conveying path from a vertical first orientation to a second orientation pivoted with respect to the vertical; a first supporting device that is configured to support a transport pouch pivoted into the second orientation during conveying along a second section of the conveying path by means of the two bearing points of the rear wall of the transport pouch; and a second supporting device that is configured to support the front wall of a transport pouch during conveying along a third section of the conveying path.

The first supporting device and the second supporting device are configured in such a manner that in a region in which the second section and the third section of the conveying path overlap, the transport pouch has a determined, geometrically defined opening.

The position of a transport unit or a transport pouch on said first, second or third sections of the conveying path refers to the position of the carrier element of the associated transport unit on the trajectory of the overhead conveyor device.

The first section of the conveying path begins when the front wall of the transport pouch of the transport unit interacts with the pivoting device and ends when the interaction between said front wall and said pivoting device ends. The second section of the conveying path begins when the two bearing points of the rear wall of the transport pouch of the transport unit are supported by the first supporting device and ends when said two bearing points are no longer supported by said first supporting device. The third section of the conveying path begins when the front wall of the transport pouch of the transport unit is supported by the second supporting device and ends when said front wall is no longer supported by said second supporting device.

Thus, for example, if the transport pouch is located in the second section of the conveyor path, this means that its carrier element arranged on the overhead conveyor device is located on the trajectory of the overhead conveyor device in this second section, the definition of the second section, however, referring to the interaction between the first supporting device and the two bearing points.

A loading device according to the invention offers multiple significant advantages.

On the one hand, it is the simplicity of the mechanical construction of the loading device that can be operated with less complex electronic control systems. This leads to significant cost savings, both in terms of purchase and operation, in particular with regard to maintenance and also energy efficiency.

Another advantage of this solution is its compatibility with simple transport pouches. In contrast to systems that rely on complex mechanisms such as ball joints and the like integrated into the transport pouches for their alignment and loading, the loading device according to the invention allows the use of simpler and more cost-effective transport pouch models. This simplification not only reduces the direct costs of the transport pouches themselves, but also minimizes the maintenance effort. Simpler transport pouches mean fewer moving parts that can fail or need to be replaced, which in turn reduces operating costs and increases the uptime of the entire system.

In addition, the loading device according to the invention is characterized by gentle handling of the transport pouches, which not only extends the service life of the transport pouches but also increases the safety and reliability of the conveying process. Furthermore, it also minimizes the risk of damage to piece goods during the loading process.

It should also be emphasized that the specific arrangement of the first and second supporting devices results in the transport pouch having a predefined, geometrically given opening. This predefined, geometrically given opening of the transport pouch makes the loading process considerably easier, since the position of the opening of the transport pouch through which loading is to take place is always the same. In particular, there is no need for additional sensors to determine the position of the opening and to adapt the loading operation thereto.

It is also advantageous that the second supporting device supports the front wall of the transport pouch from below during the loading operation, which reduces the mechanical load on the transport pouch. This support from below helps to maintain the structural integrity of the transport pouch during the loading process and prevents the transport pouch from unintentionally deforming or sinking under the weight of the piece goods.

In an advantageous embodiment of a loading device according to the invention, the first supporting device and the second supporting device run parallel to each other in the region in which the second section and the third section of the conveying path overlap.

Particularly advantageously, the distance between the first supporting device and the second supporting device is smaller than the maximum possible distance between the front wall and the rear wall of the transport pouch.

This arrangement results in the fact that the transport pouch cannot open to the maximum possible distance between the front wall and the rear wall of the transport pouch. Instead, the resulting opening of the transport pouch is given by the distance between the first supporting device and the second supporting device so that when the position and geometry of the transport pouch are known, the position of the opening of the transport pouch can be directly determined in a reliable manner

According to another advantageous embodiment of a loading device according to the invention, it is provided that the third section of the conveying path follows downstream of the first section of the conveying path and does not overlap with the first section.

Thus, the transport pouch is brought into its pivoted position in the first section, while it is supported just in the third section, so that it can be loaded safely. In this manner, a clear, stable sequence of steps is created in the process flow in which the pivoting of the transport pouch and the opening of the transport pouch are separated steps.

According to another advantageous embodiment of a loading device according to the invention, it is provided that the pivoting device is configured as a passive device, in particular non-actively driven device, which contacts the front wall of the transport pouch of the transport unit during conveying of the transport unit in the first section of the conveying path.

This configuration makes it possible to reduce the mechanical complexity of the device. Since the pivoting device does not require any active actuator elements, there is no need for motors, sensors and the associated control electronics. This simplification results in more cost-effective production and installation as well as reduced maintenance costs over the lifetime of the system. Furthermore, the complexity of the control software of the loading device is reduced as there are fewer actuators and sensors.

Furthermore, the reliability of the conveyor installation is increased. In passive systems there are fewer moving parts that can fail. This leads to improved availability of the system and a reduction in downtimes.

In another advantageous embodiment of a loading device according to the invention, the pivoting device has a ramp, a stop, a barrier and/or at least one horizontal roller arranged transverse to the conveying path.

One advantage of this configuration is the simplicity and robustness of the design. Ramps and rollers are mechanically simple elements that offer high reliability and durability with minimal maintenance. These properties help to reduce operating costs and increase the availability of the system by reducing downtime due to defects or maintenance work.

Furthermore, the use of a ramp or roller allows for a smooth and controlled pivot movement of the transport pouch. This is particularly advantageous at higher operating speeds since abrupt movements, which could damage the transport pouches, are avoided.

Moreover, this embodiment offers a high degree of flexibility in terms of adaptability to different pouch sizes and shapes. Both ramps and rollers can be configured such that they are compatible with a wide range of transport pouches without the need for extensive adaptation of the device. This allows for versatile use of the loading device and quick adaptation to changing requirements in logistics and production.

In another advantageous embodiment of a loading device according to the invention, it is provided that the two bearing points are arranged in a lower region of the rear wall of the transport pouch.

Particularly advantageously, the two bearing points are arranged at an end of the rear wall of the transport pouch facing away from the carrier element of the transport unit.

The arrangement of the bearing points in the lower region of the rear wall allows for optimized load distribution across the rear wall of the transport pouch. In the second section of the conveying path, the rear wall of the transport pouch is thus mounted on three points, namely on the carrier element of the transport unit and on the two bearing points on the first supporting device. The result is a stable, geometrically defined mounting of the rear wall of the transport pouch.

These bearing points can be implemented in various ways, wherein in any case the bearing points must be configured to interact with the first supporting device in such a manner that as a result, the rear wall is supported on the first supporting device. For example, the bearing points can be configured as projections, protruding wire brackets, pins, sleeves or rollers.

According to another advantageous embodiment of a loading device according to the invention, it is provided that the first supporting device has two parallel guide rails which are configured in such a manner that each of the two laterally projecting bearing points of the rear wall rest on one of the two guide rails during the conveying of the transport unit in the second section of the conveying path.

This configuration improves the stability and safety of the transport unit during transport. Guiding the transport pouch along the parallel rails ensures that the transport unit is moved safely along the conveying path. In particular, the simultaneous lateral positive-locking guidance of the transport pouch by the guide rails also stabilizes the transport pouch laterally.

The use of guide rails also leads to a reduction in wear on the transport unit and the conveyor installation itself. The targeted guidance minimizes friction and contact with other components of the installation, which extends the service life of the transport units and reduces maintenance costs.

Moreover, this configuration also offers a higher degree of flexibility for the loading device because the guide rails can be adapted for different types of transport units and piece goods without the need for extensive changes to the structure of the conveyor installation.

In a particularly advantageous embodiment of such a loading device, the two guide rails each have a lateral boundary, for example a guide plate, on the side facing away from the transport pouch.

This improves the precision and safety of the guide system. The guide plates serve as physical barriers that ensure additional stabilization of the transport units transverse to the conveying path.

The inclusion of lateral boundaries such as guide plates on the two guide rails, each positioned on the side facing away from the transport pouch, provides for additional stabilization of the transport units by preventing the transport pouches from slipping sideways or tilting during transport without the side walls of the transport pouch coming into contact with the guide rails. This reduces wear.

According to another advantageous embodiment of a loading device according to the invention, it is provided that the second supporting device has a roller device with a plurality of rollers arranged transverse to the conveying path.

An advantage of this embodiment lies in the minimization of the resistance that the transport pouches experience during conveying. The rollers allow for low-friction movement of the transport pouches, which reduces the energy required for transport, increases the efficiency of the entire conveyor installation, and reduces wear, in particular wear on the transport pouches.

In another advantageous embodiment of a loading device according to the invention, the loading device has a transfer unit that is configured to convey a piece goods item into a transport pouch when the transport pouch is located in the third section of the conveying path.

One advantage of this configuration is the increased degree of automation in the loading process. The direct integration of the transfer unit minimizes the need for manual intervention. This not only leads to an increase in productivity by speeding up the loading process, but also to a reduction in potential sources of error that can be caused by human actions.

Furthermore, it is particularly advantageous if the transfer unit has a positioning device that can adapt the position of the transfer unit to position itself precisely at the edge of the transport pouch. This additional adaptability allows for even more precise placement of the piece goods within the transport pouch, which increases the efficiency of the loading process.

Such a positioning device can be implemented in the form of a pneumatic cylinder, for example, which allows precise control of the movements. Alternatively, electric linear drives can also be used, which are known for their precise controllability and adaptability to different load conditions. These drives offer the advantage of simple integration into automated control systems that allow synchronous adaptation of the transfer unit to the dynamic conditions of the conveying process. Alternatively, hydraulic actuators can also be used if even more precise positioning is required.

At the end of the transfer unit, the integration of a damping element can also be particularly advantageous. Such a damping element can help to dampen the forces acting on the transport pouch and its contents, in particular at the moment when the transport pouch is lifted after completion of the loading process, thereby minimizing the risk of damage during lifting.

Advantageously, in a loading device according to the invention, the front wall and the rear wall of the transport pouch are oriented parallel to each other and are pivotally connected by spacer elements so that the front wall and the rear wall and the spacer elements together form a parallelepiped.

Such a configuration is particularly advantageous for establishing a geometrically defined opening of the transport pouch by the first supporting device and the second supporting device.

This configuration further allows optimum space utilization within the transport pouch since the parallel alignment of the walls creates a uniformly formed internal space that facilitates the storage and transport of piece goods, in particular of cuboid packages. The transport pouch can adapt dynamically thanks to the pivotable spacer elements. This flexibility in adapting the pouch thickness to the respective load volume leads to a more efficient use of the available space within the conveyor installation and thus allows for optimization of the transport capacities.

A second aspect of the invention relates to a device for unloading transport units loaded with piece goods in an overhead conveyor device.

Such an unloading device according to the invention comprises an overhead conveyor device having at least one transport unit with a carrier element and a transport pouch mounted on the carrier element in a pivotably suspended manner, wherein the overhead conveyor device is designed to convey the at least one transport unit along a conveying path in a conveying direction, wherein the transport pouch of the at least one transport unit has a rear wall that is mounted on the carrier element of the transport unit in a pivotably suspended manner, and wherein the said rear wall has two bearing points that are each arranged projecting laterally on one side of the rear wall, and a front wall that is movably connected to the rear wall and runs ahead of the rear wall in the conveying direction; a pivoting device that is configured to interact with the front wall of a transport pouch of a transport unit conveyed along the conveying path of the overhead conveyor device in order to pivot the transport pouch during conveying along a first section of the conveying path from a vertical first orientation to a second orientation pivoted with respect to the vertical; and a first supporting device that is configured to support a transport pouch pivoted into the second orientation during conveying along a second section of the conveying path by means of the two bearing points of the rear wall of the transport pouch.

The overhead conveyor device and the first supporting device are configured in such a way that in a third section of the conveying path, the rear wall of the transport unit is pivoted so far backwards in the conveying direction that the rear wall has a negative slope.

In the context of this description, a negative slope of the rear wall of the transport pouch of the transport unit is to be understood as meaning that one end of the rear wall facing away from the carrier element (which in the vertical transport position of the transport pouch is the lower end of the rear wall) is located above the other end of the rear wall (which in the transport position of the transport pouch is the upper end of the rear wall). Therefore, there is a gradient in the conveying direction between said lower end of the rear wall and said upper end of the rear wall.

Such an unloading device has various advantages.

The pivotable arrangement of the transport pouch on the carrier element allows flexible adaptation of the pouch positioning during the unloading process.

The position of a transport unit, or a transport pouch, respectively, on said first, second or third sections of the conveying path refers to the position of the carrier element of the associated transport unit on the trajectory of the overhead conveyor device.

The first section of the conveying path begins when the front wall of the transport pouch of the transport unit interacts with the pivoting device and ends when the interaction between said front wall and said pivoting device ends. The second section of the conveying path begins when the two bearing points of the rear wall of the transport pouch of the transport unit are supported by the first supporting device and ends when said two bearing points are no longer supported by said first supporting device. The third section of the conveying path begins when the rear wall of the transport pouch reaches a negative slope and ends when the rear wall of the transport pouch no longer has a negative slope.

If, for example, the transport pouch is located in the second section of the conveying path, this means that its carrier element arranged on the overhead conveyor device is located on the trajectory of the overhead conveyor device in this second section, but the definition of the second section refers to the interaction between the first supporting device and the two bearing points.

The pivoting device, which interacts with the front wall of the transport pouch, ensures precise control of the pouch orientation, which simplifies and speeds up the automated unloading process. This mechanism ensures that the transport pouch is pivoted to the angle necessary for the first supporting device to safely pick up the transport pouch.

The integration of a supporting device aimed to support the bearing points of the rear wall of the transport pouch during the conveying contributes to the stability of the transport pouch. This stability is important to allow safe and controlled unloading of the piece goods from the transport pouch. By avoiding unnecessary movement or swaying of the transport pouch during the unloading process, the risk of damage to the piece goods is minimized. It also ensures that the piece goods are specifically unloaded in the intended section.

Due to the fact that in the third section of the conveying path, the rear wall of the transport unit has a negative slope in the conveying direction, the piece goods in the transport pouch can slide automatically out of the transport pouch driven by gravity. There is no need for additional actuators, in particular electronic, pneumatic, hydraulic or other components. This design helps to simplify the unloading process, reduces the energy consumption of the unloading device and minimizes the maintenance effort. The reliability of the overall installation is improved, since there are fewer driven parts and components that could fail.

In an advantageous embodiment, an unloading device according to the invention comprises an unloading chute that is configured to receive piece goods sliding out of the transport pouch of a transport unit in the third section of the conveying path so that the received piece goods can slide on the unloading chute driven by gravity to a destination zone.

One advantage of such a solution is the optimization of the material flow. By guiding the piece goods directly after leaving the transport pouch onto a chute that leads them to a specific destination zone, intermediate steps are eliminated. This increases the speed and efficiency of the unloading process.

Moreover, the unloading chute improves the safety and integrity of the transported piece goods. Due to the controlled sliding on the chute, impacts and falls that could occur if the piece goods were dropped directly onto the floor or onto a conveyor belt are avoided. This is particularly important for fragile or sensitive piece goods whose risk of damage is thus minimized.

According to another advantageous embodiment of an unloading device according to the invention, it is provided that the pivoting device is configured as a passive device, in particular as a non-actively driven device, which contacts with front wall of the transport pouch of the transport unit during the conveying of the transport unit in the first section of the conveying path.

This configuration makes it possible to reduce the mechanical complexity of the device. Since the pivoting device does not require any active actuator elements, there is no need for motors, sensors and the associated control electronics. This simplification results in more cost-effective production and installation, as well as reduced maintenance requirements and costs over the life of the system. Furthermore, the complexity of the control software of the loading device is reduced, since there are fewer actuators and sensors.

Furthermore, the reliability of the conveyor installation is increased. In the case of passive systems, there are fewer parts that can fail. This leads to improved availability of the system and a reduction in downtimes, which is important in production and logistics environments.

In another advantageous embodiment of an unloading device according to the invention, the pivoting device has a ramp, a stop, a barrier, and/or at least one horizontal roller arranged transverse to the conveying path.

The integration of a ramp in the pivoting device provides continuous, gentle guidance of the transport pouch from a vertical to an inclined position, which facilitates the transition to the second section of the conveying path.

A pivoting device with a horizontal roller allows a transport pouch to be pivoted with minimal friction, which reduces mechanical stress on the transport pouches, which may be loaded with heavy or voluminous piece goods.

Such pivoting devices are maintenance-friendly. The use of ramps and rollers reduces the number of driven parts and the complexity of the system, which leads to a reduction in maintenance requirements and an extension of the service life of the components.

In another advantageous embodiment of an unloading device according to the invention, the two bearing points are arranged in a lower region of the rear wall of the transport pouch.

Particularly advantageously, the two bearing points are arranged at an end of the rear wall of the transport pouch facing away from the carrier element of the transport unit.

The arrangement of the bearing points in the lower region of the rear wall allows optimized load distribution across the rear wall of the transport pouch. In the second section of the conveying path, the rear wall of the transport pouch is thus mounted on three points, namely on the carrier element of the transport unit and on the two bearing points on the first supporting device. This results in a stable, geometrically defined mounting of the rear wall of the transport pouch.

These bearing points can be implemented in various ways, wherein in any case the bearing points must be configured to interact with the first supporting device in such a manner that as a result, the rear wall is supported on the first supporting device. For example, the bearing points can be configured as protrusions, protruding wire brackets, pins, sleeves or rollers.

According to another advantageous embodiment of an unloading device according to the invention, it is provided that the first supporting device has two parallel guide rails, which are configured such that each of the two laterally protruding bearing points of the rear wall rest on one of the two guide rails when conveying the transport unit in the second section of the conveying path.

This configuration increases the stability and safety of the transport unit during transport. Guiding along the parallel rails ensures that the transport unit moves evenly along the conveying path.

In the unloading device according to the invention, such a configuration has the further advantage that in the third section of the conveying path, in which the rear wall of the transport unit has a negative slope in the conveying direction, no gravity-induced lateral sheering of the transport pouch is possible since the two guide rails enclose the transport pouch laterally in a form-locking manner.

The use of guide rails also reduces wear on the transport unit and the conveyor installation itself. The targeted guidance minimizes friction and contact with other installation components, which extends the service life of the transport units and rails and reduces maintenance costs.

Moreover, this configuration increases the flexibility of the unloading device since the guide rails can be adapted to different types of transport units and piece goods without the need for major changes to the structure of the conveyor installation.

In a particularly advantageous embodiment of such an unloading device, the two guide rails have a lateral boundary, for example a guide plate, on each side facing away from the transport pouch.

This improves the precision and safety of the guide system. The guide plates serve as physical barriers that ensure additional stabilization of the transport units transverse to the conveying path.

The inclusion of lateral boundaries, such as guide plates, on the two guide rails, each positioned on the side facing away from the transport pouch, provides for additional stabilization of the transport units by preventing the transport pouches from slipping sideways or tilting during transport without the side walls of the transport pouch coming into contact with the guide rails.

In another advantageous embodiment of an unloading device according to the invention, the first supporting device has a vibration means.

Such a vibration means is intended to subject a transport pouch to an oscillating or vibrating movement in a targeted manner, in order to facilitate the sliding of the piece goods out of the transport pouch. The vibrations facilitate the unloading of piece goods from the transport pouch by reducing the friction between the piece goods and the inner surface of the pouch. The targeted application of vibrations to the transport unit or the transport pouch can also loosen jammed loads or loads adhering to the inner wall so that problem-free unloading is made possible.

Such vibration means can be implemented, for example, with actuators which interact with a transport pouch and cause it to vibrate in a targeted manner. For this purpose, the actuators can shake the transport pouch directly, or they can shake a part of the first supporting device when the bearing points of the transport pouch are located thereon.

Alternatively, such a vibration means can also be configured as a passive device, for example as a sawtooth-shaped or stair-shaped segment of a guide rail of the first supporting device. If the bearing points of the transport pouch slide or roll over this segment of the guide rail when the transport unit is conveyed along the conveying path, the bearing points jump and the transport pouch is shaken accordingly. The two guide rails can also be configured in such a manner that a shaking movement of the transport pouch also occurs laterally, transverse to the conveying direction, for example by a phase shift of the parallel, sawtooth-shaped or staircase-shaped guide rails in the conveying direction.

Advantageously, in an unloading device according to the invention, the front wall and the rear wall of the transport pouch are oriented parallel to each other and are pivotably connected by spacer elements so that the front wall and the rear wall and the spacer elements together form a parallelepiped.

The parallel alignment of the front wall and rear wall of the transport pouch resulting from this configuration allows a piece good item to slide reliably out of the transport pouch in the third section of the conveying path. Since the rear wall of the transport unit has a negative slope in the conveying direction, the front wall of the transport pouch also has a negative slope. The load of the transport pouch can now slide downwards on the inner surface of the front wall and out of the opening of the transport pouch, where it gets onto the unloading chute.

A third aspect of the invention relates to an overhead conveyor installation.

Such an overhead conveyor installation according to the invention comprises at least one loading device according to the invention, and/or at least one unloading device according to the invention.

Such an overhead conveyor installation according to the invention has the advantage that the overhead conveyor device of the loading device and/or the unloading device can be configured as part of an overhead conveyor device of the overhead conveyor installation, which avoids interfaces.

An overhead conveyor installation that integrates both loading and unloading devices offers the advantage that a complex logistics process can be implemented within a single overhead conveyor device.

The combination of loading and unloading devices results in a significant reduction in manual handling efforts. Automated loading and unloading operations reduce the need for manual intervention, reduce the risk of accidents at work and improve working conditions for staff.

Furthermore, precision and safety are increased when handling piece goods. Automated processes ensure consistent handling of loads, which minimizes the risk of damage.

Finally, the integration of loading and unloading devices into a unified system allow more efficient use of space and resources. The combination of both functions in an overhead conveyor installation reduces the need for additional equipment and saves valuable space.

### BRIEF DESCRIPTION OF SEVERAL VIEWS OF THE DRAWINGS

The present invention is explained in greater detail below on the basis of preferred embodiments and with reference to the attached figures. Further advantages, features, preferences and aims of the invention are disclosed thereby. These references should not be construed as limiting the present invention but are intended to be exemplary only.

Components that are identical, or that are identical at least in terms of their function, are designated below by identical or at least comparable reference numbers.

FIG. 1A shows a schematic perspective view of an empty transport pouch with view on the rear wall.

FIG. 1B shows a schematic side view of the transport pouch from FIG. 1A in the loaded state, with view on the front wall.

FIG. 2A shows a schematic rear view of a transport unit with a transport pouch, in one embodiment of the bearing point.

FIG. 2B shows a schematic rear view of a transport unit with a transport pouch, in another embodiment of the bearing point.

FIG. 2C shows a schematic rear view of a transport unit with a transport pouch, in yet another embodiment of the bearing point.

FIG. 3A shows a schematic side view of a loading device in one phase of the loading process.

FIG. 3B shows a schematic side view of a loading device in another phase of the loading process.

FIG. 3C shows a schematic side view of a loading device in another phase of the loading process.

FIG. 3D shows a schematic side view of a loading device in another phase of the loading process.

FIG. 3E shows a schematic side view of a loading device in another phase of the loading process.

FIG. 3F shows a schematic side view of a loading device in another phase of the loading process.

FIG. 3G shows a schematic side view of a loading device in another phase of the loading process.

FIG. 4 shows a schematic side view of a different loading device with a fixedly mounted transfer unit.

FIG. 5A shows a schematic side view of an unloading device with an unloading chute and a destination zone with an automated guided vehicle, in one phase of the unloading process.

FIG. 5B shows a schematic side view of an unloading device with an unloading chute and a destination zone with an automated guided vehicle, in another phase of the unloading process.

FIG. 6 shows a schematic side view of an unloading device with an unloading chute and a destination zone with a horizontal conveyor.

FIG. 7 shows a schematic side view of an unloading device without an unloading chute and a destination zone with a collection container.

### DETAILED DESCRIPTION OF THE INVENTION

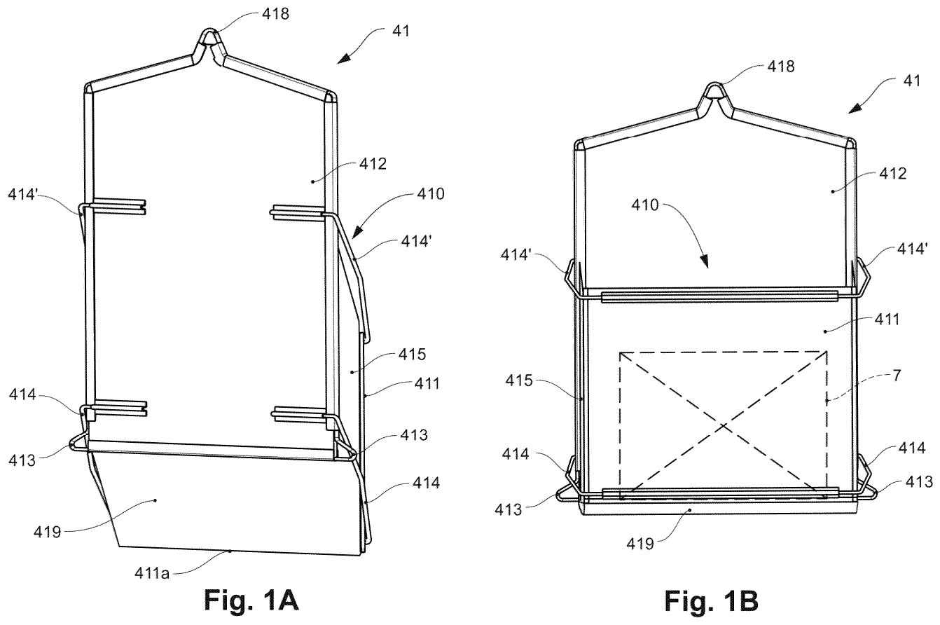

FIG. 1A shows a transport pouch 41 designed for use in an overhead conveyor device 5.

The transport pouch 41 has a substantially rigid rear wall 412, at an upper end of which a hook 418 is arranged by means of which the transport pouch can be mounted in a suspended manner on a carrier element (not shown) of a transport unit of an overhead conveyor device. The hook 418 is part of a wire bracket which encloses the edges of the rear wall 412 and gives the rear wall mechanical stability.

A substantially rigid, in any case stable, front wall 411 is movably connected to the rear wall 412 via four spacer elements 414, 414′. Each of the four spacer elements 414, 414′ is pivotably connected to the rear wall 412 and the front wall 411 so that the rear wall 412 and the front wall 411 are always parallel to one another but can still be arranged at a variable distance from one another. The rear wall 412, the front wall 411 and the spacer elements 414, 414′ form a parallelepiped.

The front wall of a transport pouch suitable for use in a loading device or an unloading device according to the invention does not necessarily have to be rigid (in the narrow sense of the term). The only thing that is relevant is that piece goods can slide easily on the inner side of the front wall to allow easy loading and unloading. For example, it is conceivable that the front wall is implemented as a film stretched on a frame. In addition, it is conceivable that the corresponding walls are not completely flat, as in the examples shown, but have curved surfaces or surface structures that allow them to slide without any problems. It may also be advantageous to configure the front wall with a curve to ensure that the pivoting device runs as smoothly as possible and, in particular, to avoid jolts.

The rear wall of such a transport pouch does not have to be rigid in its entirety either. In principle, it is sufficient for the basic structure of the rear wall to be sufficiently stable to allow it to be mounted on the three bearing points (hooks 418, bearing points 413).

Two pivot elements 414 and 414′, respectively, are implemented as a wire bracket. The ends of the wire bracket are pivotably mounted on the rear wall 412, and the middle part of the wire bracket is pivotably mounted on the front wall.

Two flexible side walls 415 and a base 419 together with the rear wall 412 and the front wall 411 form an internal space of the transport pouch 41 in which piece goods 7 can be stored for transport. At an end of the internal space opposite to the base 419 of the pouch, there remains an opening 410 of the transport pouch 41 through which the piece goods 7 can be introduced into the internal space of the transport pouch or removed from the internal space.

The transport pouch 41 shown in FIG. 1A is empty. Due to the self-weight of the bottom 419 and front wall 411, the spacer elements 414 pivot downwards so that the distance between the front wall 411 and the rear wall 412 is minimized.

At a lower end of the rear wall 412, the surrounding wire bracket of the rear wall 412 forms two loops 413 that project outwards beyond the rear wall. These loops delimit, among other things, the pivoting movement of the lower spacer elements 414, thus defining a maximally closed configuration of the transport pouch 41. On the other hand, they serve as bearing points 413 of the transport pouches 41 in connection with the loading and unloading devices according to the invention, which will be discussed in more detail later.

FIG. 1B shows the same transport pouch 41, loaded with a piece goods item 7 in the form of a cuboid package. Due to the self-weight of the bottom 419 and front wall 411 and additionally the weight of the piece goods item 7 acting on the base 419, the front wall 411 is also pushed towards the rear wall 412. The piece goods item 7 is therefore enclosed or clamped flush between the front wall 411 and the rear wall 412.

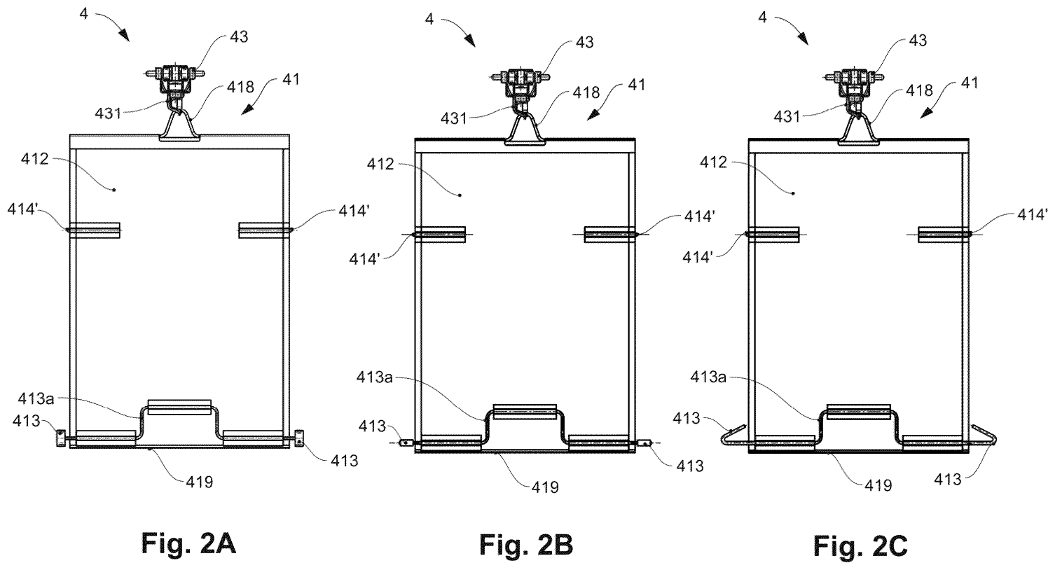

FIGS. 2A-2C show three further variants of a transport unit 4, which differ in the design of the bearing points 413. The transport unit 4 comprises a carrier element 43 in the form of a carriage, as well as a transport pouch 41. The rear wall 412 is mounted on a carrying hook 431 of the carrier element 43 in a suspended manner via a hook 418. As in the previous example, the upper spacer elements 414′ are implemented by a wire bracket. The lower spacer elements 414, on the other hand, are implemented by a rigid base 419 pivotably connected to the rear wall 412 and the front wall 411. The bearing points 413 are secured to the ends of a wire element 413a that is secured to the rear wall 412 in a rotationally fixed manner.

In FIG. 2A, the bearing points 413 are configured as rollers which are rotatably mounted on the wire element 413a. These rollers are advantageous because they allow low-friction rolling on the first supporting device of a loading device or unloading device according to the invention.

In FIG. 2B, the bearing points 413 are implemented as cylindrical sleeves or rotatable bushings made of plastic, for example polyethylene or PTFE, which are attached to the ends of the wire element 413a. The sleeves or bushings reduce the sliding friction of the bearing points on a first supporting device of a loading or unloading device according to the invention. The sleeves are inexpensive and can be replaced quickly and without any problems.

In the transport unit in FIG. 2C, the bearing points 413 are implemented as hook-shaped bent ends of the wire element 413a. In this case, these bent wire pieces slide directly on the first supporting device of a loading or unloading device according to the invention.

In an even simpler embodiment, the two ends of the wire element 413a, as mere protruding wire ends without further modification, serve directly as bearing points 413.

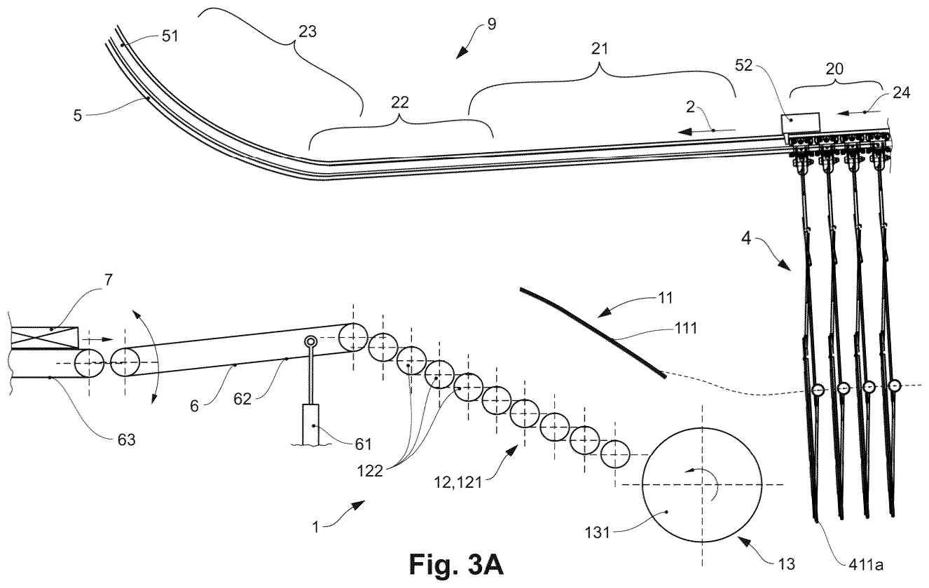

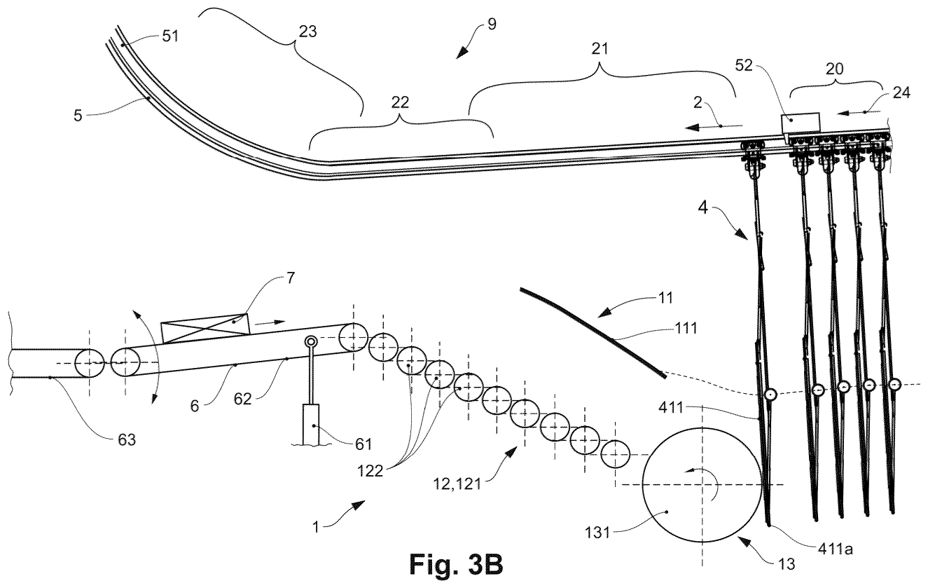

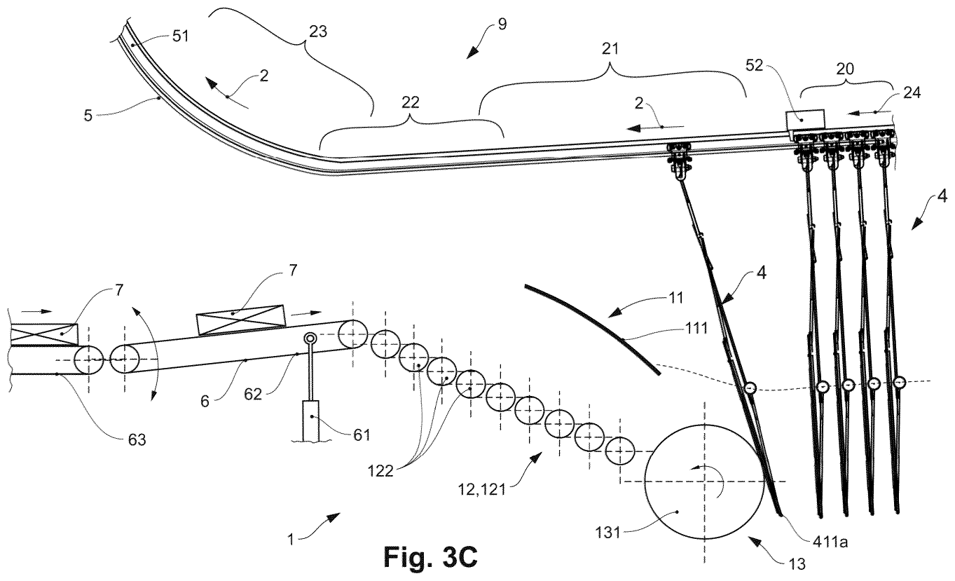

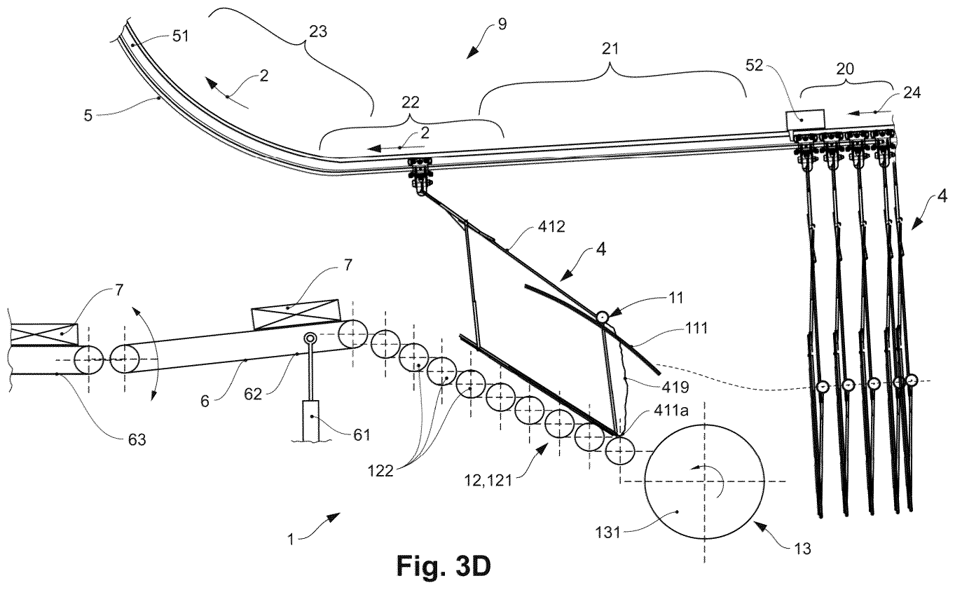

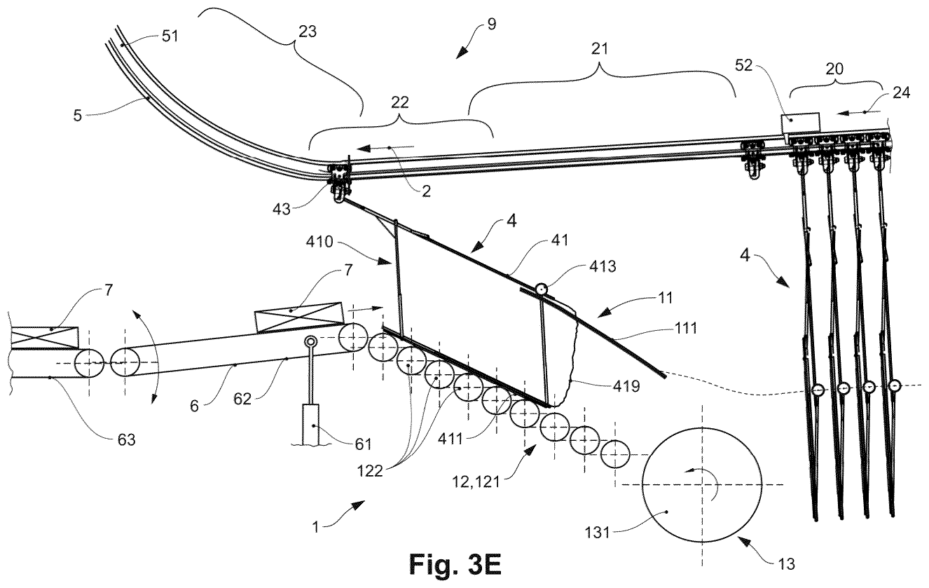

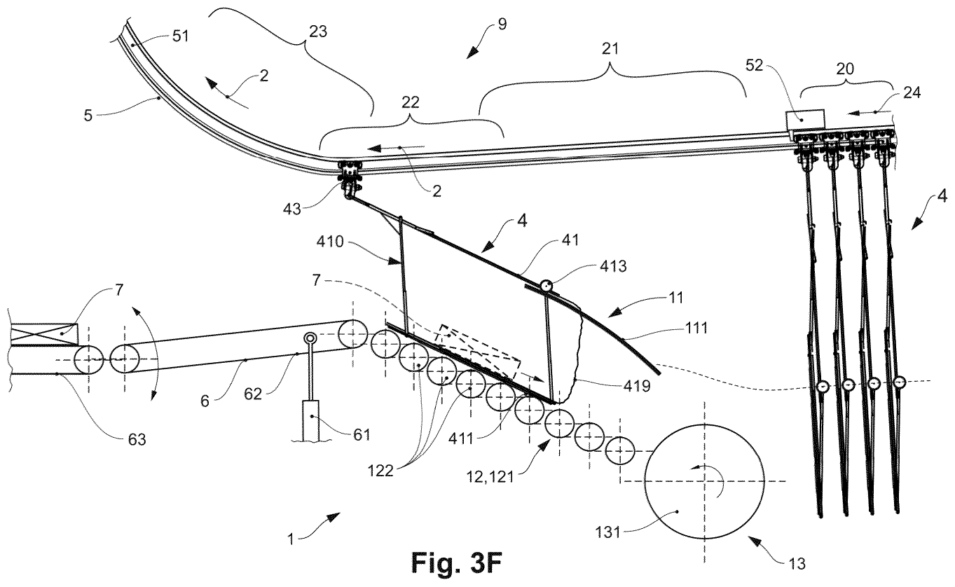

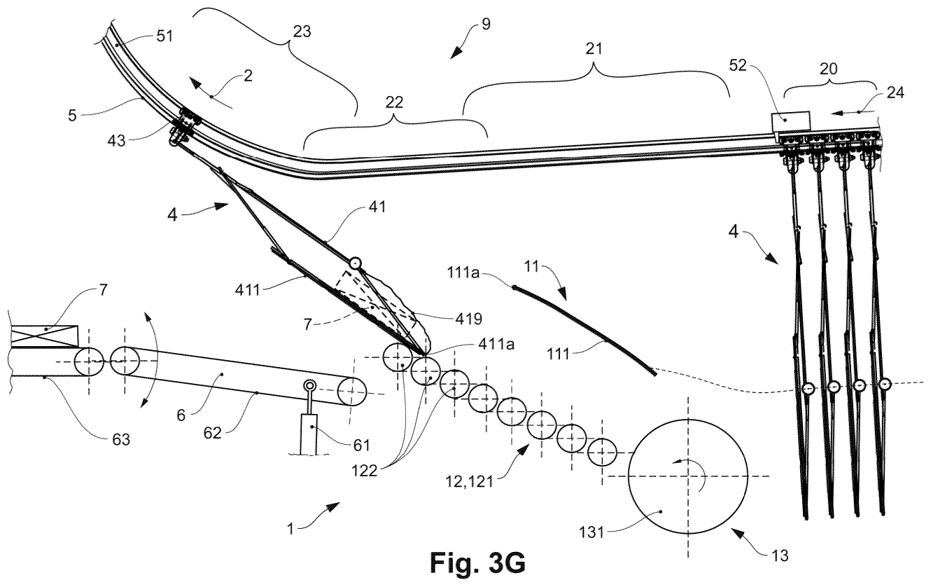

FIGS. 3A-3G show various phases of a loading process of a transport pouch 41 in an advantageous embodiment of a loading device 1 according to the invention. Within this loading device 1, a transport unit 4 is moved along a conveying path 2 in a conveying direction 24. The conveying path 2 corresponds to the conveyor rail 51 of the overhead conveyor device 5. The transport unit 4 corresponds substantially to the transport unit 4 as discussed in FIGS. 1A, 1B.

In particular, it is also possible to use a transport pouch as disclosed, for example, in FIG. 1a in Swiss Patent Application No. CH000981/2023 of 7 Sep. 2023, from the same applicant, having the title “Vorrichtungen und Verfahren zum Beschicken von Transporttaschen eines Hängeförderers” (“Devices and methods for loading transport pouches of an overhead conveyor”). As is apparent to those skilled in the art, structural parts of the loading device shown there can also be suitably used in the loading and unloading devices shown here. The disclosure content of the aforementioned patent application is hereby incorporated by reference in its entirety into this description.

In the example shown, the bearing points 413 are configured as rollers. The pouch base 419 is flexible. The carriage of the supporting element 43 is mounted on the conveyor rail 51 so that it can be displaced by rolling.

In an upstream section of the conveying path 2, transport units 4 with empty transport pouches that are passively fed by gravity in a buffer zone 20 are stopped by a stopper element 52 and thus buffered for later use (see FIG. 3A).

If a transport unit 4 is to be fed to the loading device 1, the stopper element 52 releases the front transport unit. A drive device (not shown) now interacts with the carriage 43 of the transport unit 4 and actively conveys it in the conveying direction 24. The drive device can be configured, for example, as a circulating drive chain that reversibly couples to a driver pin of the carriage 43 of the transport unit 4. The transport unit now arrives at the pivoting device 13 of the loading device 1 (see FIG. 3B).

As soon as the front wall 411 of the transport pouch 41 of the transport unit 4 abuts against the pivoting device 13 implemented as a freely rotating roller 131, the first section 21 of the conveying path 2 begins, along which the transport pouch of the transport unit is brought from the vertical transport position into a pivoted position (cf. FIG. 3C with the transport pouch in an intermediate position).

The bearing points 413 of the transport pouch 41 of the transport unit 4 follow the path shown as a dashed line. This line finally intersects with the first supporting device 11. The first supporting device 11 has two parallel guide rails 111 which are arranged on both sides of the conveyor rail 51. When the bearing points 413 come into contact with said guide rails 111 of the first supporting device 11, the rear wall 412 is supported on three points, namely the two bearing points 413 that rest on the guide rails 111 of the first supporting device 11, and on the hook 418 that rests in the carrying hook of the carriage 43. The second section 22 of the conveying path begins, in which the rear wall 412 of the transport pouch of the transport unit is supported by the first supporting device 11.

As the carriage 43 is further conveyed in the conveying direction 24, the alignment and movement of the rear wall 412 of the transport pouch 41 is now defined by the first supporting device 11 in conjunction with the position of the carriage 43 on the conveyor rail 51. The front wall 411 of the transport pouch initially continues to slide over the roller 131 of the pivoting device 13 until finally only the lower edge 411a of the front wall 411 rests on the roller 131. During the further conveying, the transport pouch 41 now opens under the self-weight of the front wall 411. However, since the lower edge 411a of the front wall continues to be supported by the roller 131, this process takes place in a steady and controlled manner until finally the lower edge 411a also loses contact with the roller, and the first section 21 of the conveying path ends.

The transport pouch now opens further until the front wall 411, or possibly initially only the lower edge 411a of the front wall 411, rests on the second supporting device 12. The third section 23 of the conveying path 2 begins (cf. FIG. 3D).

The second supporting device 12, which is designed as a roller device 121, consists of an arrangement of rollers 122 that are in direct contact with the front wall 411 of the transport pouch 41 and allow the front wall 411 to slide with little friction. The use of rollers 122 aims to reduce friction and thus to minimize wear on the front wall 411 of the transport pouch 41.

A corresponding roller device is also disclosed in Swiss Patent Application No. CH000981/2023 in FIGS. 1a, 1b, 2a-2f and 5a-5f.

During the further conveying of the transport unit along the conveying path 2, the front wall 411 remains in contact with the second supporting device 12. For geometrical reasons, the alignment of the rear wall 412 changes at the same time until it is finally in the loading position (see FIG. 3E) parallel to the roller arrangement 121 of the second supporting device 12. The drive device now interrupts the further conveying of the transport units 4.

In this loading position, the front wall 411 of the transport pouch 41 now rests flat on the roller arrangement. The geometric arrangement of the conveyor rail 51, the first supporting device 11, and the second supporting device 12 is advantageously selected such that the transport pouch 41 is open to a lesser degree than would be the case in this position of the transport pouch due to the self-weight of the front wall 411 etc. without the second supporting device 12. This results in a geometrically clearly defined, reproducible opening 410 of the transport pouch 41.

A transfer unit 6 of the loading device 1 is designed to introduce the piece goods 7 to be transferred into the transport pouch 41. A piece goods item 7 is conveyed onto a belt conveyor 62 of the transfer unit 6 via an upstream belt conveyor 63. A positioning unit 61, which is implemented in the form of a pneumatic cylinder, holds the belt conveyor 62 in an upper position as illustrated. The belt conveyor 62 of the transfer unit 6 now conveys the piece goods item 7 through the opening 410 into the internal space of the transport pouch 41.

A corresponding transfer unit is also disclosed in the Swiss Patent Application No. CH000981/2023 in FIGS. 1a, 1b, 2a-2f and 5a-5f.

The positioning unit 61 ensures the precise alignment of the transfer unit 6 during loading, so that it is positioned exactly at the opening of the transport pouch 41, which allows the piece goods 7 to be smoothly inserted into the transport pouch 41. Since the position of the opening 410 of the transport pouch 41 is defined and fixed in the loading position, no complex detection means are needed.

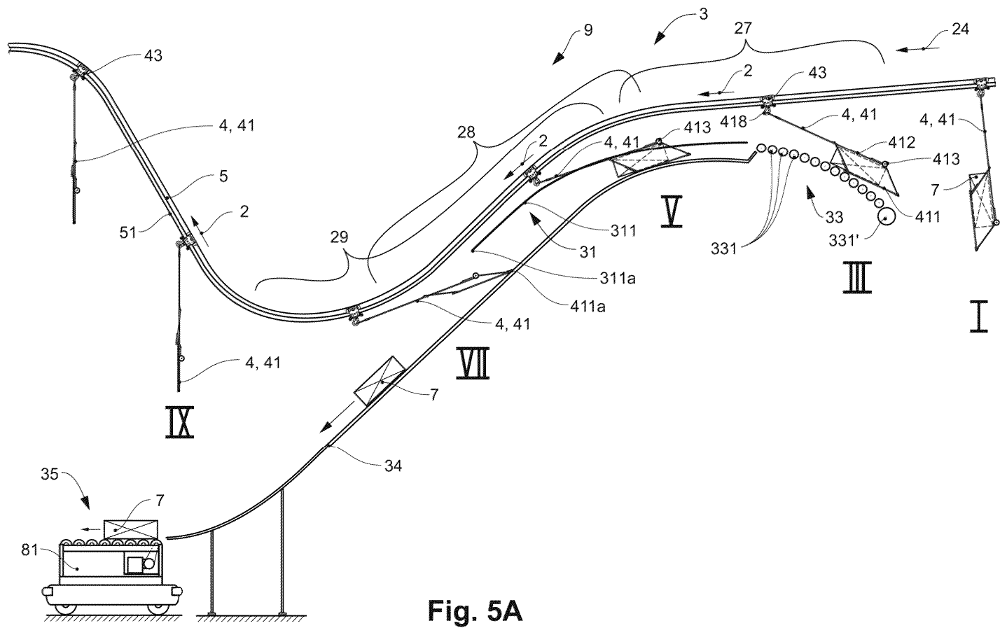

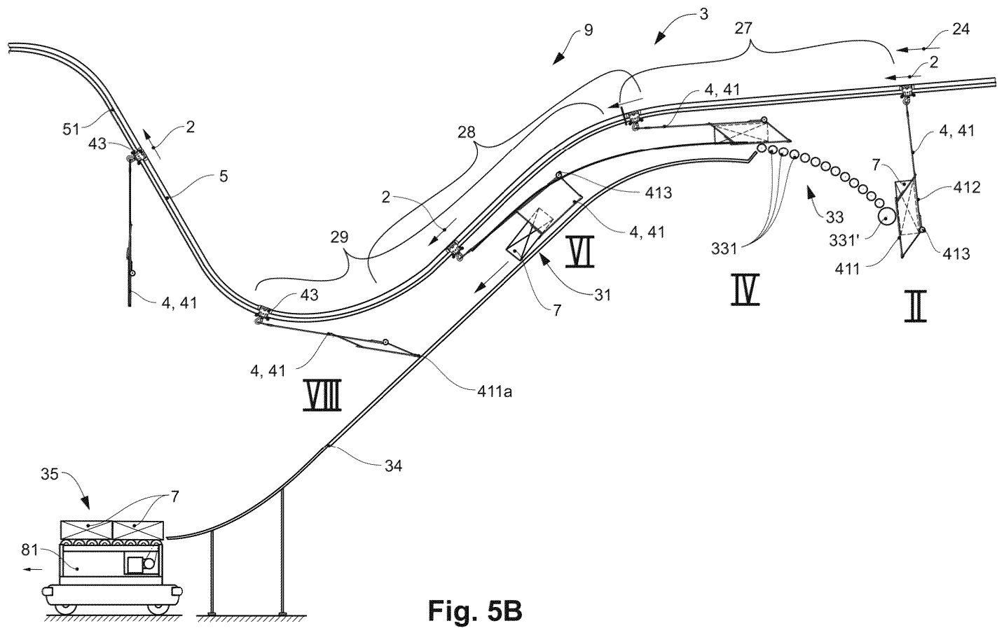

Furthermore, the positioning unit 61 can also be used to insert multiple layers of piece goods into the transport pouch, as disclosed in Swiss Patent Application No. CH000981/2023 in FIGS. 2a-2f and 5a-5f.

Finally, after transferring to the transport pouch 41, the piece goods 7 slide further downwards on the inner side of the front wall 411 in the direction of the pouch base 419, driven by gravity (cf. FIG. 3F).

After the transport pouch 41 of the transport unit 4 has been loaded, the drive device conveys the transport pouches in the loading device 1 further along the conveying path 2. The positioning unit 61 pivots the belt conveyor 62 downwards so that it does not get in the way of the transport unit in this phase after loading. During the further conveying of the transport unit 4 along the conveying path 2, the front wall 411 of the transport pouch 41, in particular the lower edge 411a of the front wall 411, initially continues to be supported by the second supporting device 12 (cf. FIG. 3G). The bearing points 413 of the rear wall 412, on the other hand, reach the end 111a of the guide rails 111 of the first supporting device 11. The bearing points 413 are no longer supported by the first supporting device 11, and the second section 22 of the conveying path 2 thus ends. Due to its self-weight, the rear wall 412 pivots downwards about the hook 418 until the rear wall 412 rests on the piece goods item 7 in the transport pouch 41. The filled transport pouch 41 is now closed again and ready for further transport (cf. FIG. 3G).

Once the transport unit 4 is conveyed further, it finally lifts off the second supporting device 12 and returns to the vertically suspended transport position (not shown). The end of the third section 23 of the conveying path is reached.

In another advantageous embodiment of a loading device 1 according to the invention (not shown), the first supporting device is implemented with an extended length. The guide rails of the first supporting device are arranged such that a transport pouch, in particular its front wall, cannot come into contact with elements of the loading device, in particular the belt conveyor of the transfer unit. This protects the material of the loading device and the transport units, and less free space needs to be provided, which allows for a more compact configuration of the device. Furthermore, this also prevents the transport pouch from swinging excessively when returning to the vertical loading position.

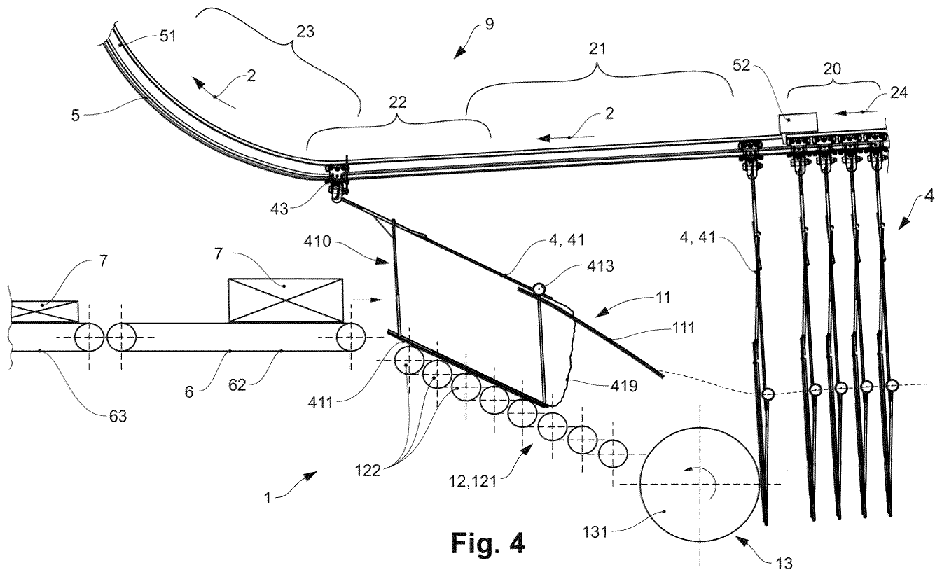

FIG. 4 shows another embodiment of a loading device 1 according to the invention with a fixedly mounted transfer unit 6. This arrangement does not require an additional positioning unit 61 for raising and lowering the transfer unit 6.

In the loading device 1 in FIGS. 3A-3G, only one transport unit 4 is conveyed through the loading device 1 at a time. However, in order to increase the throughput, two or more transport units 4 can be conveyed through the loading device 1 at the same time, wherein these transport units are in different phases. For example, in FIG. 4, a transport pouch 41 of a first transport unit 4 contacts the roller 131 of the pivoting device 13 (analogous to FIG. 3B) while a transport pouch 41 of a second transport unit 4 is already in the loading position (analogous to FIG. 3E). The work-cycle can be compressed even further compared to FIG. 4, while it is only necessary to avoid that successive transport units influence each other in such a manner that the loading sequence is disturbed.

FIGS. 5A and 5B show a schematic side view of an unloading device 3 according to the invention in various phases I to IX of the unloading process.

The unloading device 3 is used for unloading a transport pouch 41 loaded with a piece goods item 7 of a conveyed transport unit 4. The transport pouch 41 is suspended from a carrier element 43 in the form of a carriage. The transport unit 4 corresponds substantially to the transport unit 4 as discussed in FIGS. 1A, 1B. However, the bearing points 413 are configured as rollers. The carriage 43 is mounted for rolling displacement in the conveyor rail 51 of the overhead conveyor device 5.

In the overhead conveyor device 5 of the unloading device 3, the transport units are preferably actively conveyed by a drive unit (not shown). The drive device can be designed, for example, as a circulating drive chain which couples reversibly to a driver pin of the carriage 43 of a transport unit.

The unloading device 3 has a pivoting device 33 that is intended to pivot the transport pouch 41 in a first section 27 of the conveying path from a vertical, first orientation (cf. transport unit 4 in phases I, II) to a second orientation (cf. transport unit 4 in phases III, IV). The pivoting device 33 shown is designed as a roller device with a plurality of rollers 331′, 331. The first section 27 of the conveying path begins when the front wall 411 of the transport pouch 41 of a transport unit contacts the first roller 331′ (cf. transport unit 4 in phase I). The pivoting then takes place in the first section 27 of the conveying path 2. The rollers 331′, 331 reduce the friction between the transport pouch 41, in particular the front wall 411 thereof, and the pivoting device 33.

Alternatively, the pivoting device could also be configured as a ramp, on which the front wall 411 of the transport pouch 41 slides. Furthermore, the pivoting device can also be configured as a stop or guide plate or barrier, or as another passive obstacle which, by interacting with the front wall 411 of the transport pouch 41, geometrically causes the transport pouch to pivot into the second orientation.

During further conveying along the conveying path 2, the transport unit 4 finally reaches a first supporting device 31 (cf. transport unit 4 in phases IV, V, VI).

The first supporting device 31 has two parallel guide rails 311, which are arranged on both sides of the conveyor rail 51. If the bearing points 413 of the rear wall 412 of the transport pouch 41 now come into contact with said guide rails 311 of the first supporting device 31, the rear wall 412 is supported on three support points, namely on the two bearing points 413, which rest on the first supporting device 31, and on the hook 418 of the rear wall, which rests in the carrying hook of the carriage 43. The second section 28 of the conveying path 2 begins, in which the rear wall 412 of the transport pouch 41 of the transport unit 4 is supported by the first supporting device 31.

It should be noted that the first supporting device 31 must be configured such that the unloading device 3 can be loaded with transport units 4 with differently filled transport pouches 41. An unloading device 3 must be able to unload both transport pouches that are filled with piece goods 7 of the maximum possible thickness, and empty transport pouches 41 that are conveyed for an undetermined reason, namely in such a manner that no interference can occur. In the unloading device 3 shown, the first supporting device 31 is therefore extended so far backwards towards the pivoting device 33 that empty transport pouches can also be transferred to the first supporting device 31 without any problems (namely in phase IV). On the other hand, when the transport pouches are filled to the maximum, the bearing points 413 of the transport pouch 41 rest on the first supporting device 31 at the latest in phase VI, at which point the second section 28 of the conveying path also begins.

Normally, however, the more or less voluminously filled transport pouch 41 of a transport unit 4 falls with its front wall 411 onto the unloading chute 34 after the front wall 411 has previously reached the end of the pivoting device 33 (after phase IV). This ends the first section 27 of the conveying path 2.

During the further conveying of the carriage 43 in the conveying direction 24, the distance between the unloading chute 34, on which the front wall slides (see phase V), and the guide rails 311 of the first supporting device 31 now increases continuously until finally the bearing points 413 of the rear wall rest on the guide rails 311 and thus the rear wall 412 is supported by the first supporting device 31. The beginning of this second section 28 of the conveying path thus depends on the thickness of the loaded transport pouch 41.

As the distance between the unloading chute 34 and the first supporting device 31 continues to increase, the transport pouch 43 now opens due to the self-weight of the front wall and the piece goods 7, while the front wall 411 continues to slide on the unloading chute.

The emptying of the transport pouch 41 begins when the rear wall 412 of the transport pouch 41 reaches a negative slope (see phases V, VI), so that gravity begins to act on the piece goods 7 in such a manner that they can slide out of the transport pouch 41. This is where the third section 29 of the conveying path 2 begins, with the second section 28 overlapping with the third section 29 of the conveying path 2.

As soon as the transport unit 4 is located both in the third section 29 of the conveying path 2 and the front wall 411 of the transport pouch 41 has a negative slope, i.e. a gradient in the direction of the opening 410 of the transport pouch 41, and in the second section 28 of the conveying path 2 in which the transport pouch is open, the goods 7 in the transport pouch can slide driven by gravity on the inner side of the front wall 411 of the transport pouch 41 towards the opening 410, and then onto the unloading chute 34 (cf. phase VI). On the unloading chute 34, the piece goods 7 then slide, driven by gravity, further towards a destination zone 35.

Finally, a maximum opening of the transport pouch corresponding to the current alignment of the rear wall is reached, and the front wall of the transport pouch is lifted off the unloading chute 34 (cf. phase VI).

At the end, the removed piece goods 7 reach a destination zone 35 for further processing. In the exemplary embodiment shown, an automated guided vehicle (AGV) 81 is located in the destination zone, which takes over the piece goods 7 and can transport them independently to a predetermined destination.

Finally, the bearing points 413 reach the end 311a of the guide rails 311, and the rear wall 412 of the transport pouch 41 is no longer supported. The second section 28 of the conveying path 2 is completed. The now empty transport pouch 41 falls onto the unloading chute 34, and the lower edge 411a of the front wall 411 slides on the unloading chute 34 as the transport unit 4 continues to be conveyed (see phases VII, VIII).

As soon as the rear wall 412 of the transport pouch 41 no longer has a negative slope, in principle the third section 29 of the conveying path 2 also ends, although at this point this no longer plays a role for the already emptied transport pouch.

Finally, the transport pouch 41 of the transport unit 4 lifts off the unloading chute 34 and pivots back into the vertical transport position (see phase IX).

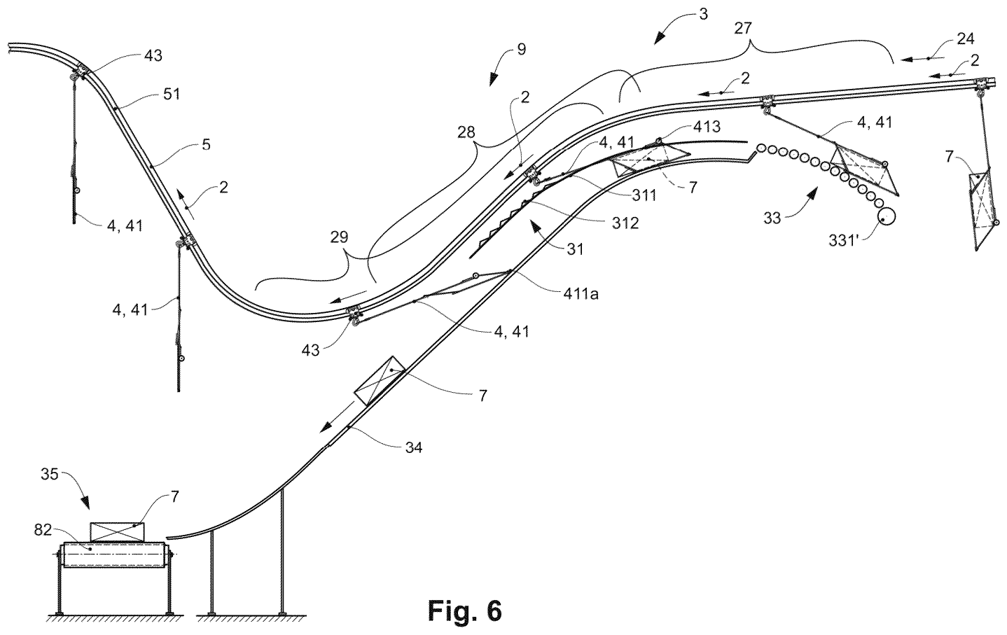

FIG. 6 shows an alternative embodiment of such an unloading device 3 according to the invention in which a horizontal conveyor 82 in the form of a belt conveyor is provided in the destination zone 35, which takes over the unloaded piece goods 7 and conveys them onward for further processing.

In FIG. 6, an additional vibration means 312 is provided, which serves to support the emptying of the transport pouch. In the example shown, this vibration means is designed as a toothed segment 312 at the end of the guide rails 311 of the first supporting device. When the bearing points 413 of the transport pouch 41 slide or roll over this segment, the transport pouch is set into vibration. This allows to shake the piece goods 7 out of the transport pouch 41.

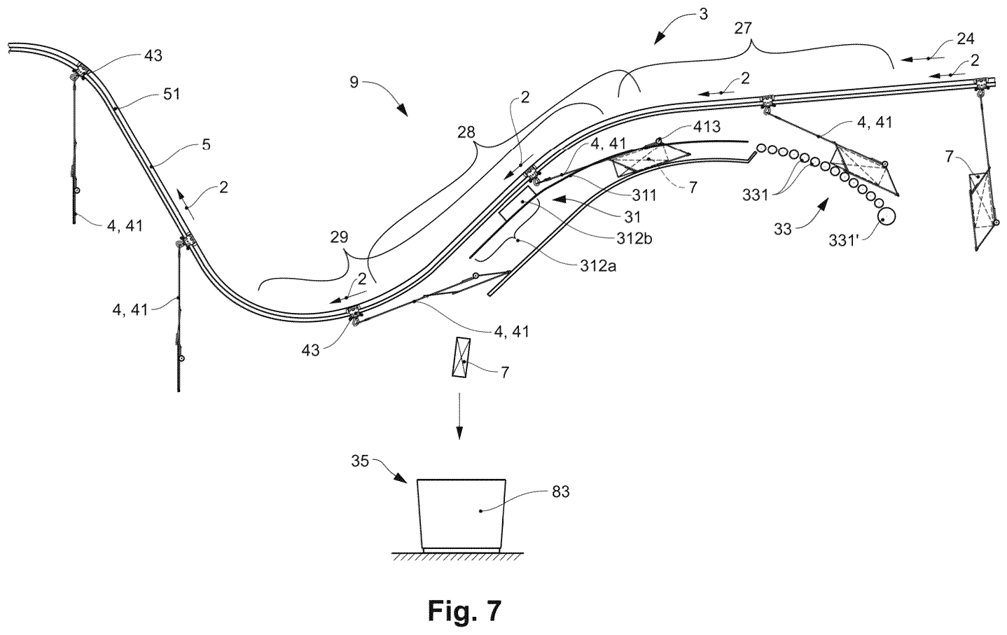

Alternatively, the vibration means can also be configured as an active shaking actuator 312b. For example, an actuator in the form of a shaker unit can shake a certain segment 312a of the guide rail 311, as shown in FIG. 7, in order to shake a piece goods item 7 out of the transport pouch 41. For example, such a shaker 312b can be activated specifically when the transport unit passes a light barrier (not shown). This reduces the complexity of controlling the actuator 312b.

In the embodiment variant of the unloading device 3 according to the invention in FIG. 7, the unloading chute 34 also ends above the destination zone 35 so that the unloaded piece goods 7 fall into a collecting container 83 in the destination zone 35.

Alternatively, the transport pouch 41 itself can also be jolted or shaken directly by an active actuator.

The present invention is not to be limited in scope by the specific embodiments described herein. Indeed, various modifications of the present invention, in addition to those described herein, will be apparent to those skilled in the art from the foregoing description and accompanying figures. Thus, such modifications are intended to fall within the scope of the appended claims.

It should be understood that various changes, substitutions, and alterations can be made herein without departing from the spirit and scope of the invention as defined by the appended claims. It should also be apparent that individual elements identified herein as belonging to a particular embodiment may be included in other embodiments of the invention. Moreover, the scope of the present application is not intended to be limited to the particular embodiments of the process, machine, manufacture, and composition of matter, means, methods and steps described in the specification. As one of ordinary skill in the art will readily appreciate from the disclosure herein, processes, machines, manufacture, composition of matter, means, methods, or steps, presently existing or later to be developed that perform substantially the same function or achieve substantially the same result as the corresponding embodiments described herein may be utilized according to the present invention.

Additionally, various references are cited throughout the specification, the disclosures of which are each incorporated herein by reference in their entirety.

1. A loading device (1) for loading transport units in an overhead conveyor device, comprising:
an overhead conveyor device (5) having at least one transport unit (4) with a carrier element (43) and a transport pouch (41) mounted on the carrier element in a pivotably suspended manner, wherein the overhead conveyor device (5) is configured to convey the at least one transport unit along a conveying path (2) in a conveying direction (24), wherein the transport pouch (41) of the at least one transport unit (4) comprises a rear wall (412) that is mounted on the carrier element (43) of the transport unit (4) in a pivotably suspended manner, and wherein the rear wall (412) has two bearing points (413) that are each arranged projecting laterally on one side of the rear wall (412), and a front wall (411) that is movably connected to the rear wall and runs ahead of the rear wall (412) in the conveying direction (24);
a pivoting device (13) that is configured to interact with the front wall (411) of a transport pouch (41) of a transport unit (4) conveyed along the conveying path of the overhead conveyor device (5), in order to pivot the transport pouch (41) during conveying along a first section (21) of the conveying path from a vertical first orientation to a second orientation pivoted with respect to the vertical;
a first supporting device (11) that is configured to support a transport pouch (41) pivoted into the second orientation during conveying along a second section (22) of the conveying path (2) by means of the two bearing points (413) of the rear wall (412) of the transport pouch; and
a second supporting device (12) that is configured to support the front wall (411) of a transport pouch (41) during conveying along a third section (23) of the conveying path (2);
wherein the first supporting device (11) and the second supporting device (12) are configured in such a manner that in a region in which the second section (22) and the third section (23) of the conveying path (2) overlap, the transport pouch (41) has a determined, geometrically defined opening.

2. The loading device (1) according to claim 1, wherein in the region in which the second section (22) and the third section (23) of the conveying path (2) overlap, the first supporting device (11) and the second supporting device (12) run parallel to each other.

3. The loading device (1) according to claim 1, wherein the third section (23) of the conveying path (2) follows downstream after the first section (21) of the conveying path (2) and does not overlap with the first section (21).

4. The loading device (1) according to claim 1, wherein the pivoting device (13) is configured as a passive, non-actively driven device, which contacts the front wall (411) of a transport pouch (41) of a transport unit (4) during conveying of the transport unit (4) in the first section (21) of the conveying path (2).

5. The loading device (1) according to claim 1, wherein the pivoting device (13) comprises at least one of a ramp, a stop, a barrier, and at least one horizontal roller (131) arranged transverse to the conveying path.

6. The loading device (1) according to claim 1, wherein the two bearing points (413) are arranged in a lower region of the rear wall (412) of the transport pouch (41).

7. The loading device (1) according to claim 1, wherein the first supporting device (11) has two parallel guide rails (111) that are configured in such a manner that each of the two laterally projecting bearing points (413) of the rear wall (412) rest on one of the two guide rails (111) during the conveying of the transport unit (4) in the second section (22) of the conveying path (2).

8. The loading device (1) according to claim 7, wherein the two guide rails (111) each have a lateral boundary on the side facing away from the transport pouch (41).

9. The loading device (1) according to claim 1, wherein the second supporting device (12) has a roller device (121) with a plurality of rollers (122) arranged transverse to the conveying path (2).

10. The loading device (1) according to claim 1, wherein the loading device (1) has a transfer unit (6) that is configured to convey a piece goods item (7) into a transport pouch (41) when the transport pouch (41) is located in the third section (23) of the conveying path (2).

11. The loading device (1) according to claim 1, wherein the front wall (411) and the rear wall (412) of the transport pouch (41) are oriented parallel to each other and are pivotably connected by spacer elements (414) so that the front wall (411) and the rear wall (412) and the spacer elements together form a parallelepiped.

12. An unloading device (3) for unloading transport units loaded with piece goods (7) in an overhead conveyor device, comprising:
an overhead conveyor device (5) having at least one transport unit (4) with a carrier element (43) and a transport pouch (41) mounted on the carrier element in a pivotably suspended manner, wherein the overhead conveyor device (5) is designed to convey the at least one transport unit (4) along a conveying path (2) in a conveying direction (24), wherein the transport pouch (41) of the at least one transport unit (4) has a rear wall (412) that is mounted on the carrier element (43) of the transport unit (4) in a pivotably suspended manner, and wherein the said rear wall (412) has two bearing points (413) that are each arranged projecting laterally on one side of the rear wall (412), and a front wall (411) that is movably connected to the rear wall (412) and runs ahead of the rear wall (412) in the conveying direction (24);
a pivoting device (33) that is configured to interact with the front wall (411) of a transport pouch (41) of a transport unit (4) conveyed along the conveying path (2) of the overhead conveyor device (5) in order to pivot the transport pouch (41) during conveying along a first section (27) of the conveying path (2) from a vertical first orientation to a second orientation pivoted with respect to the vertical; and
a first supporting device (31) that is configured to support a transport pouch (41) pivoted into the second orientation during conveying along a second section (28) of the conveying path (2) by means of the two bearing points (413) of the rear wall of the transport pouch (41);
wherein the overhead conveyor device (5) and the first supporting device (31) are configured in such a manner that in a third section (29) of the conveying path (2), the rear wall (412) of the transport unit (4) is pivoted so far backwards in the conveying direction (24) that the rear wall (412) has a negative slope.

13. The unloading device (3) according to claim 12, wherein the unloading device (3) comprises an unloading chute (34) that is configured to receive piece goods (7) sliding out of a transport pouch (41) of the transport unit (4) in the third section of the conveying path (2) so that the received piece goods (7) can slide on the unloading chute (34) driven by gravity to a destination zone (35).

14. The unloading device (3) according to claim 12, wherein the pivoting device (33) is configured as a passive, non-actively driven device, which contacts the front wall (411) of the transport pouch (41) of the transport unit (4) during the conveying of the transport unit in the first section (27) of the conveying path (2).

15. The unloading device (3) according to claim 12, wherein the pivoting device (33) comprises at least one of a ramp, a stop, a barrier, and at least one horizontal roller (331) arranged transverse to the conveying path (2).

16. The unloading device (3) according to claim 12, wherein the two bearing points (413) are arranged in a lower region of the rear wall (412) of the transport pouch (41).

17. The unloading device (3) according to claim 12, wherein the first supporting device (31) has two parallel guide rails (311) that are configured such that the two laterally protruding bearing points (413) of the rear wall each rest on one of the two guide rails (311) during the conveying of the transport unit (4) in the second section (28) of the conveying path (2).

18. The unloading device (3) according to claim 17, wherein the two guide rails (311) each have a lateral boundary on the side facing away from the transport pouch (41) and/or a guide plate.

19. The unloading device (3) according to claim 12, wherein the first supporting device (31) has a vibrating means (312).

20. The unloading device (3) according to claim 12, wherein the front wall (411) and the rear wall (412) of the transport pouch (41) are oriented parallel to each other and are pivotably connected by spacer elements (414) so that the front wall (411) and the rear wall (412) and the spacer elements (414) together form a parallelepiped.

21. An overhead conveyor installation (9) with at least one loading device (1) according to claim 1.

22. An overhead conveyor installation (9) with at least one unloading device (3) according to claim 12.
